(19) United States
(12) Patent Application Publication
(10) Pub. No.: US 2015/0128501 A1
(43) Pub. Date: May 14, 2015

(54) HINGE RECEIVER, DOOR INCLUDING A HINGE RECEIVER, METHOD OF FABRICATING A DOOR, AND METHOD OF FABRICATING A HINGE RECEIVER

(71) Applicant: Kelly Thomas MURPHY, Bozeman, MT (US)

(72) Inventor: Kelly Thomas MURPHY, Bozeman, MT (US)

(21) Appl. No.: 14/080,189

(22) Filed: Nov. 14, 2013

(51) Int. Cl. E05D 5/02

(52) U.S. Cl. CPC E05D 5/02
USPC 49/381; 16/382; 156/293; 29/428

(57) ABSTRACT

A hinge receiver includes at least one aperture defined by a first wall, and at least two holes defined by second walls. A door includes a substrate and a hinge receiver embedded in the substrate. A method of fabricating a door includes placing at least one hinge receiver in a form, and filling the form with a material. A method of fabricating a hinge receiver includes forming a first ring wall adjacent to two second ring walls.

### BACKGROUND

There are numerous conventional applications of concrete, such as roadways, bridges, pilings, and building structures. Concrete may also be used as an artistic medium, e.g. concrete sculpture. Concrete may also be finished to have a variety of different surface textures and appearances. In architectural contexts, concrete may be used in structures such as walls, floors, and even countertops, which may be finished in a number of different ways to provide aesthetic appeal. However, concrete presents significant disadvantages due to the weight of the material. Therefore, a finished concrete structure must usually be formed in the final location where the structure is to reside due to the burden of moving the heavy object that is formed of concrete.

Glass fiber reinforced concrete uses glass fibers and an assortment of admixtures, instead of gravel aggregate, to achieve strength. The resulting mixture in glass fiber reinforced concrete is substantially stronger than traditional concrete. The increased strength of glass fiber reinforced concrete allows for thinner and lighter applications of the material than are possible with conventional concrete. Glass fiber reinforced concrete may be used to form objects such as countertops, planters, and even furniture. While glass fiber reinforced concrete has been conventionally used in place of conventional concrete in order to make the concrete structures lighter and easier to move, there has been limited application of glass fiber reinforced concrete in structures where the use of concrete is unconventional.

### SUMMARY

In an embodiment of the present invention, a hinge receiver includes at least one aperture defined by a first wall; at least two holes defined by second walls; and at least one reinforcement member adjacent to at least the first wall or at least one of the second walls; wherein the at least two holes are adjacent to the at least one aperture, a dimension of the at least one aperture is larger than dimensions of the at least two holes, and a straight line through centers of the at least two holes does not cross a center of the at least one aperture.

In another embodiment of the present invention, a door includes a substrate; a hinge receiver embedded in the substrate, the hinge receiver comprising at least one aperture defined by a ring-shaped first wall, and at least two holes defined by ring-shaped second walls, wherein the at least one aperture and the at least two holes are exposed on a side of the substrate, a diameter of the at least one aperture is larger than diameters of the at least two holes, and a straight line through centers of the at least two holes does not cross a center of the at least one aperture.

In another embodiment of the present invention, a method of fabricating a door includes placing at least one hinge receiver in a form, wherein the hinge receiver comprises a first ring wall and two second ring walls adjacent to the first ring wall, and a longitudinal axis of the first ring wall is parallel to longitudinal axes of the two second ring walls, and the longitudinal axes of the first ring wall and the two second ring walls are perpendicular to a main surface of the form; and filling the form with a material without filling an aperture formed by the first ring wall and holes formed by the two second ring walls.

In another embodiment of the present invention, a method of fabricating a hinge receiver includes forming a first ring wall adjacent to two second ring walls, wherein a longitudinal axis of the first ring wall is parallel to longitudinal axes of the second ring walls; and placing at least one reinforcement member adjacent to at least the first ring wall or at least one of the two second ring walls.

### BRIEF DESCRIPTION OF THE DRAWINGS

FIG. 1 is perspective view of a European style concealed hinge positioned over a bore pattern.

FIG. 2A is a front perspective view of an embodiment of a hinge receiver.

FIG. 2B is a side perspective view of an embodiment of a hinge receiver.

FIG. 2C is plan view of aperture and holes.

FIG. 2D is plan view of a first ring wall and second ring walls.

FIG. 3 is a top view of an embodiment of a hinge receiver.

FIG. 4 is perspective view of a European style concealed hinge positioned over an embodiment of a hinge receiver that is embedded in a substrate.

FIG. 5 is perspective view of a jig positioned over an embodiment of a hinge receiver that is embedded in a substrate.

FIG. 6 is a front side perspective view of an embodiment of a hinge receiver.

FIG. 7 is a perspective view of an embodiment of a plate.

FIG. 8 is a backside perspective view of an embodiment of a hinge receiver embedded in a substrate.

FIG. 9 is a backside perspective view of an embodiment of a hinge receiver embedded in a substrate, with a European style concealed hinge positioned over a portion of the hinge receiver.

FIG. 10 is a top view of an embodiment of a hinge receiver.

FIG. 11 is a backside perspective view of a substrate including embodiments of hinge receivers embedded in the substrate.

FIG. 12 is a perspective view of an embodiment of a jig holding embodiments of hinge receivers.

FIG. 13 is a backside perspective view of a substrate including embodiments of hinge receivers embedded in the substrate, with a European style concealed hinge positioned over one of the hinge receivers.

FIG. 14 is a front side perspective view of an embodiment of a hinge receiver.

FIG. 15 is a top view of an embodiment of a plate.

FIG. 16 is a transparent backside perspective view of an embodiment of a hinge receiver.

FIG. 17 is a front side perspective view of an embodiment of a hinge receiver.

FIG. 18 is a backside perspective view of an embodiment of a hinge receiver.

FIG. 19 is a backside perspective view of a substrate including embodiments of hinge receivers embedded in the substrate.

FIG. 20 is a perspective view of an embodiment of a jig holding embodiments of hinge receivers.

FIG. 21 is a backside transparent perspective view of an embodiment of a hinge receiver embedded in a substrate.

FIG. 22 is a front side view of an embodiment of a hinge receiver viewed through a transparent rendering of a substrate in which the hinge receiver is embedded.

FIG. 23 is a front side view of an embodiment of a hinge receiver.

### DETAILED DESCRIPTION

While the subject matter disclosed herein is subject to various modifications and alternative constructions, certain illustrated embodiments thereof have been shown in the drawings and will be described below in detail. It should be understood, however, that there is no intention to limit the subject matter of this disclosure to the specific form disclosed, but, on the contrary, to cover all modifications, alternative constructions, and equivalents falling within the spirit and scope of the subject matter that is disclosed in this specification and defined in the claims.

In the following description and in the figures, like elements are identified with like reference numerals. The use of “such as”, “for example”, “e.g.”, “etc.”, and “or” indicates non-exclusive alternatives without limitation unless otherwise noted. The use of “including” means “including, but not limited to”, unless otherwise noted.

Applicant provides a hinge receiver that may be set in a substrate made of a material such as a cement based material, concrete, glass fiber reinforced concrete, a resinous material, a composite material, a clay/ceramic matrix material, etc. The hinge receiver may be coupled with a “European style” concealed hinge. An example of a resinous material is epoxy resin. An example of a composite material is terrazzo. Terrazzo may include one or more materials such as marble, quartz, granite, glass, or other suitable chips, which are sprinkled or un-sprinkled. The materials of terrazzo may be poured with a binder. The binder may be cement-based. Terrazzo may also be polymer-based. An example of polymer-based terrazzo is thin-set terrazzo. A binder in a polymer-based terrazzo may be a polyester resin, a vinyl ester resin, an epoxy resin, etc.

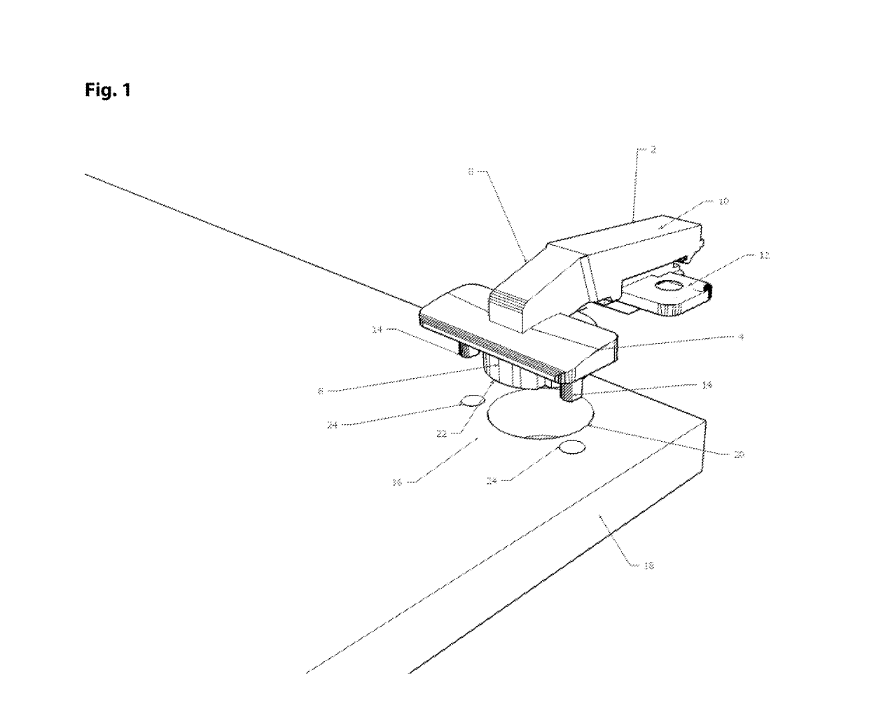

FIG. 1 illustrates an example of a structure of a European style concealed hinge 2. In this example, a flange 4 of the hinge 2 includes a cup 6, the cup is attached to a lever 8, the lever 8 is attached to a hinge arm 10, the hinge arm 10 is attached to a mounting plate 12, and the mounting plate may be mounted inside a structure such as a cabinet. In this example, the flange includes pegs 14 in a region that is peripheral to the cup 6. The flange may be coupled with a bore pattern 16 that is formed in a wood member 18. In this example, a larger size bore 20 of the bore pattern is configured to receive a bottom portion 22 of the cup 6 of the hinge, and two smaller size bores 24 adjacent to the larger size bore 20 are configured to receive the pegs 14 of the hinge, where the larger size bore has a diameter that is larger than diameters of two smaller size bores. For example, the smaller size bores may have a diameter of 8 mm and the larger size bore may have a diameter of 30 mm, 35 mm, 40 mm, etc., depending on a bore configuration that is selected by a specific manufacturer of the hinge. The diameters of the smaller size bores may be the same. Centers of the smaller size bores may be equidistant from a center of the larger size bore. A European style hinge may also include a cam mechanism that forces an outer periphery portion of the bottom portion of the cup outward against a cylindrical interior of the larger size bore; and the hinge may also include a mechanism that forces at least one outer portion of the pegs outward against cylindrical interiors of the smaller size bores. Such outward expansion of the bottom portion of the cup and/or the pegs may attach the hinge to the bore pattern.

Examples of European style concealed hinges or parts thereof may be found in U.S. Pat. No. 7,966,696 B2 to Krammer; Reissue No. RE37,236 E to Brüstle et al.; U.S. Pat. No. 8,312,597 B2 to Gallasch et al.; U.S. Pat. No. 7,448,123 B2 to Klonowski, III; U.S. Pat. No. 8,424,161 B2 to Sutterlütti; U.S. Pat. No. 8,375,518 B2 to Haemmerle; U.S. Pat. No. 8,480,189 B2 to Katz et al.; and EP 0 200 019 to Häfele K G, the contents of each of which are hereby incorporated herein by reference.

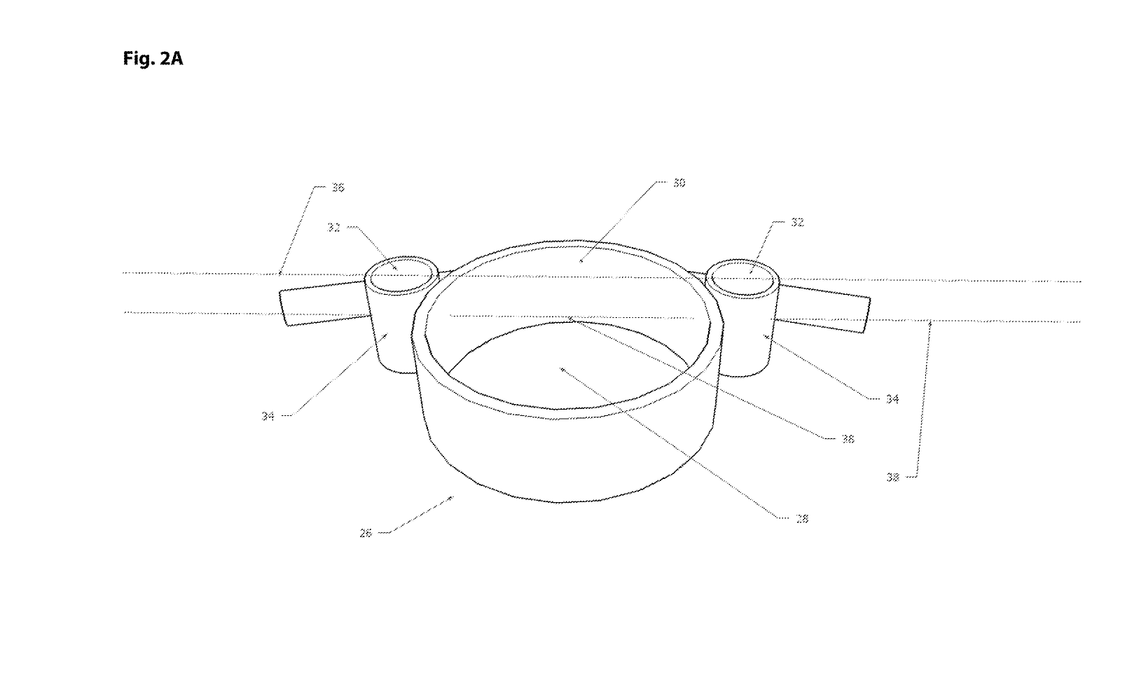

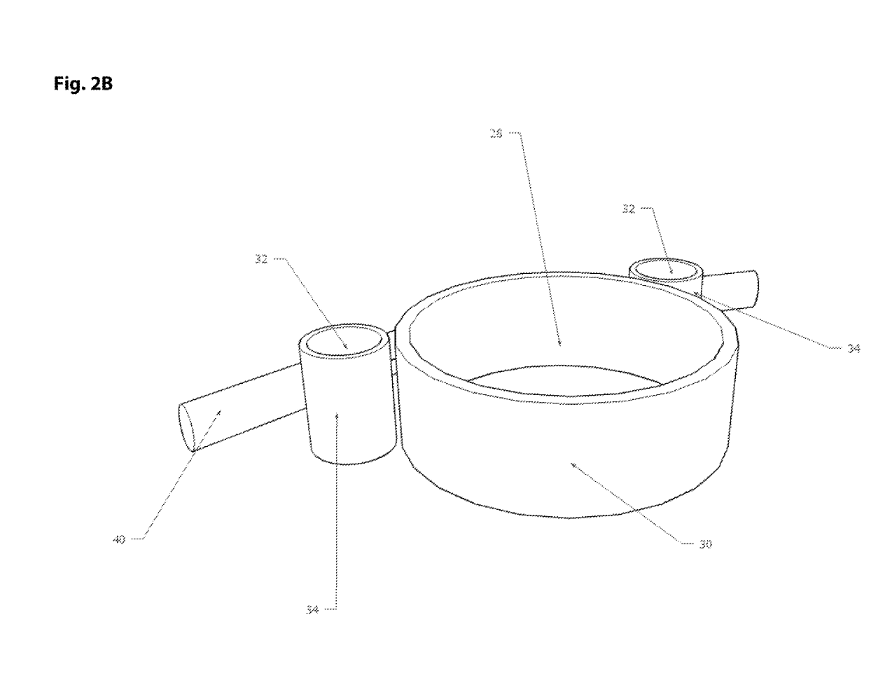

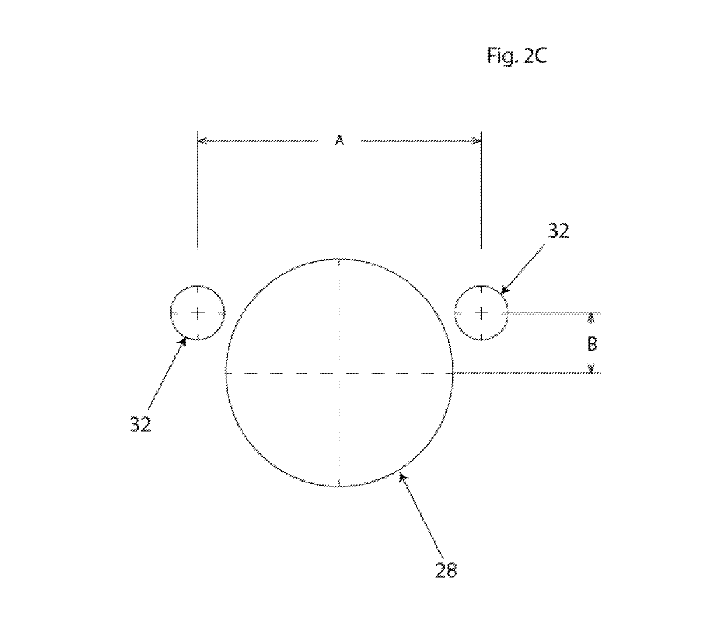

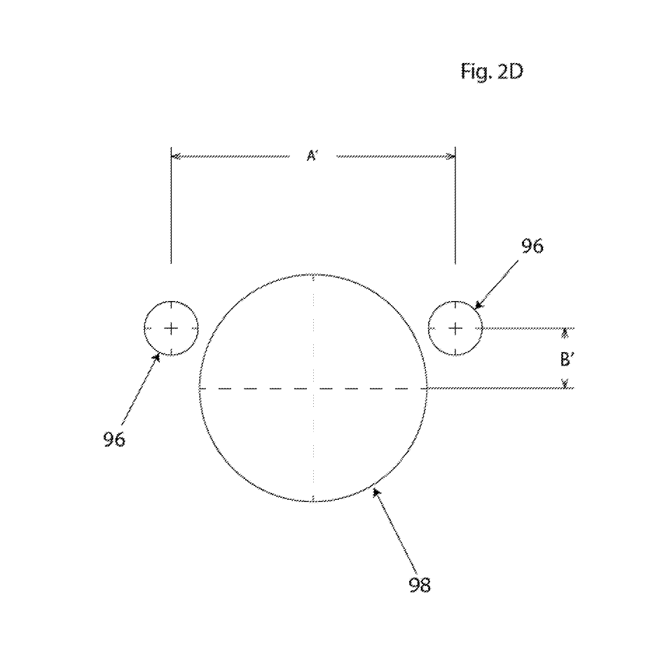

An embodiment of a hinge receiver 26 is illustrated in FIGS. 2A and 2B. A European style concealed hinge may be attached to the hinge receiver 26. In this embodiment, the following structure is provided. The hinge receiver 26 includes one aperture 28 defined by a first wall 30 that is ring-shaped, and two holes 32 are positioned adjacent to the aperture 28. The two holes are defined by second walls 34 that are ring-shaped. The aperture is formed by the first wall 30, and the holes are formed by the second walls 34. The aperture 28 and a cavity that is accessible through the aperture are formed and defined by the first wall 30; and the holes 32 and the cavities that are accessible through the holes are formed and defined by the second walls 34. The cavity that is accessible through the aperture has the same diameter as the aperture, and the cavities that are accessible through the holes have the same diameters as the holes. The first wall 30 and the second walls 34 may be hollow cylindrical pipes. A dimension of the aperture is larger than dimensions of the holes. For example, a diameter of the aperture is larger than diameters of the holes. The holes have the same diameter as each other. For example, the holes may each have a diameter of 8 mm and the aperture may have a diameter of 30 mm, 35 mm, 40 mm, etc., depending on the specific cup and/or peg sizes, and the layout of the cup and/or the pegs of a European style concealed hinge that is to be connected to the hinge receiver. It is possible that a straight line 36 passing through centers of two holes 32 adjacent to an aperture 28 does not pass through a center of the aperture. It is also possible that a straight line 38 that is perpendicular to longitudinal axes of two second walls 34 and passing through a center of a circular cross-section of a cavity that is formed by each of the two second walls does not pass through a center of a circular cross section of a cavity that is formed by the first wall 30.

A center as disclosed herein may be a center point, and centers as disclosed herein may be center points. Furthermore, an aperture as disclosed herein may be circular, and holes as disclosed herein may be circular.

In this specification, a distance between centers of two holes 32 of a hinge receiver may be denoted by A and a distance between a center of one of the two holes 32 and a line crossing a center of an aperture 28 of a hinge receiver may be denoted as B, as illustrated in FIG. 2C. In “Hettich” and “Würth” patterns, A may be 52 mm and B may be 5.5 mm. In a “Lama” pattern, A may be 48 mm and B may be 6.5 mm. In a “Mepla” pattern, A may be 48 mm and B may be 9 mm. In a “Grass” pattern, A may be 42 mm and B may be 11 mm. In “Hetal” and “Indaux” patterns, A may be 48 mm and B may be 6 mm. In a “Salice thick door” pattern, A may be 52 mm and B may be 7.5 mm. In a “Blum” pattern, A may be 45 mm and B may be 9.5 mm.

Furthermore, in this specification a distance between centers of two second ring walls 96 of a hinge receiver may be denoted as A′ and a distance between a center of one of the two second ring walls 96 and a line crossing a center of a first ring wall 98 of a hinge receiver may be denoted as B′, as illustrated in FIG. 2D. In “Hettich” and “Würth” patterns, A′ may be 52 mm and B′ may be 5.5 mm. In a “Lama” pattern, A′ may be 48 mm and B′ may be 6.5 mm. In a “Mepla” pattern, A′ may be 48 mm and B′ may be 9 mm. In a “Grass” pattern, A′ may be 42 mm and B′ may be 11 mm. In “Hetal” and “Indaux” patterns, A′ may be 48 mm and B′ may be 6 mm. In a “Salice thick door” pattern, A′ may be 52 mm and B′ may be 7.5 mm. In a “Blum” pattern, A′ may be 45 mm and B′ may be 9.5 mm.

While the embodiment of the hinge receiver 26 that is illustrated in FIGS. 2A and 2B includes one aperture 28 and two holes 32 arranged adjacent to the aperture, a hinge receiver may include any number of apertures with two holes arranged adjacent to each aperture. For example, a hinge receiver may include one, two, three, four, five, six, or more apertures with two holes arranged adjacent to each aperture. For example, the apertures may be evenly spaced in a series, the apertures may be grouped, or the apertures may be placed in any arrangement that is desired or necessary to attach the apertures to European style concealed hinges. For example, a hinge receiver may include pairs of apertures or any layout of apertures that is required for a particular substrate, such as a door, a cabinet door, etc. In addition, apertures and holes of the hinge receiver may be positioned in any configuration so that attachment between a hinge and the hinge receiver is possible.

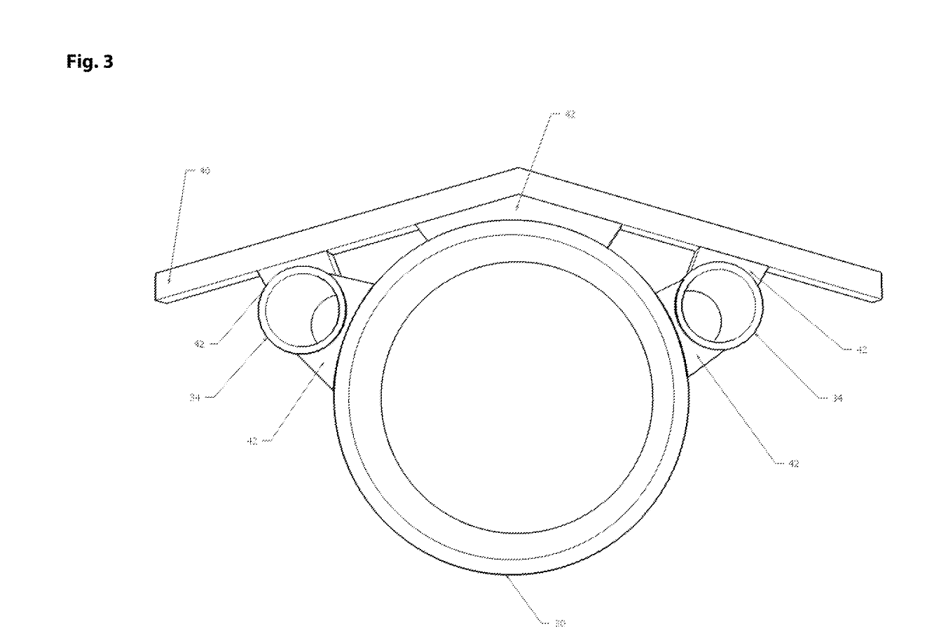

In the embodiment of the hinge receiver 26 that is illustrated in FIGS. 2A and 2B, the hinge receiver includes a reinforcement member 40 that is disposed adjacent to the aperture 28 and the holes 32. The reinforcement member may ensure that the hinge receiver does not loosen within, or pull out of, a substrate in which the hinge receiver is embedded. In this embodiment, the reinforcement member 40 is placed adjacent to the first wall 30 and the second walls 34. The reinforcement member 40 may also be attached to the first wall 30 and/or at least one of the second walls 34. For example, the reinforcement member may be attached to the first wall and/or at least one of the second walls by welding, molding, casting, forging, extruding, etc. An embodiment of a hinge receiver that is illustrated in FIG. 3 includes a first wall 30 attached to the second walls 34 by connectors 42, and a reinforcement member 40 attached to both the first wall 30 and the second walls 34 by connectors 42. The first wall, the second walls, and the reinforcement member may be welded, molded, cast, forged, extruded or otherwise manufactured together in any configuration to form a hinge receiver. The reinforcement member may be an oblong object having any cross-sectional shape such as rectangular, circular, elliptical, flat, polygonal, etc. Furthermore, the reinforcement member may be bent or strait. Embodiments of the reinforcement member 40 that are illustrated in FIGS. 2A, 2B, and 3 are bent. A longitudinal axis of a reinforcement member may be perpendicular or substantially perpendicular to a longitudinal axis of a cavity formed by the first wall 30 and/or longitudinal axes of cavities formed by the second walls 34. Furthermore, more than one reinforcement member may be placed adjacent to and/or attached to each aperture and/or at least one of the holes adjacent to each aperture. Furthermore, a series or grouping of ring walls that form apertures may be connected together with one or more reinforcement members.

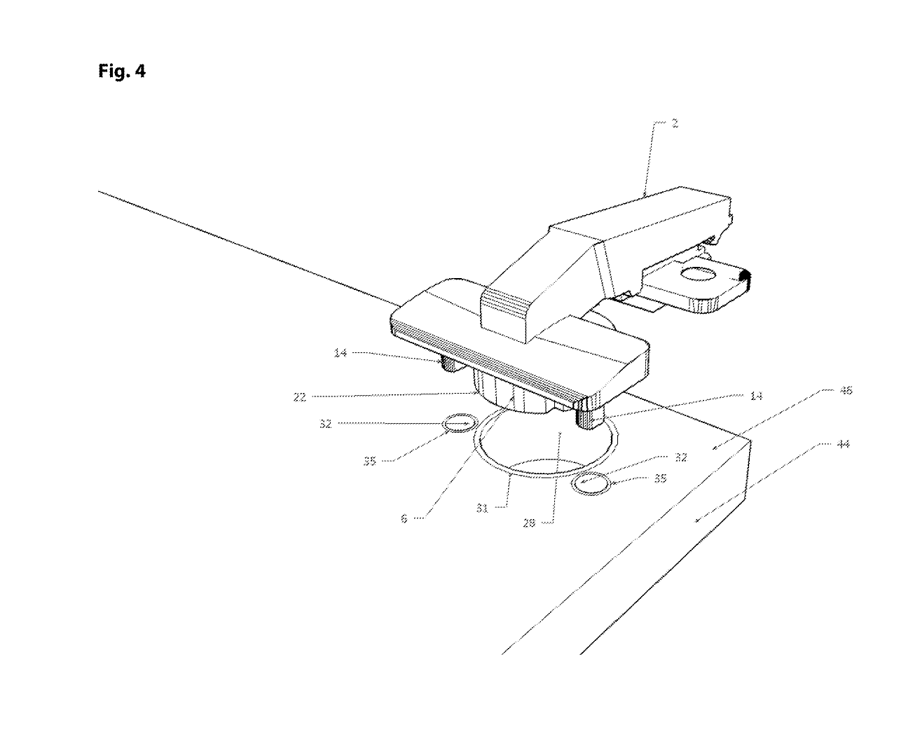

The hinge receiver may be set in a substrate, such as a door, a cabinet door, etc., made of a material, such as a cement based material, concrete, glass fiber reinforced concrete, a resinous material, a composite material, a clay/ceramic matrix material, etc., which may be cast or formed around the hinge receiver. FIG. 4 illustrates an embodiment of the hinge receiver, which is illustrated in FIGS. 2A and 2B, embedded in a substrate 44. Heights of the first wall 30 and the second walls 34, which may be measured in longitudinal directions of cavities formed by the first wall and the second walls, may be, for example only, ½ inch, while the substrate may have a depth of, for example only, ¾ inch. By providing a substrate that has a depth that that is greater than the heights of the first and second walls of the hinge receiver, a backside end 31 of the first wall 30 forming the aperture 28 and backside ends 35 of the second walls 34 forming the holes 32 may be flush with a backside 46 of the substrate 44. Furthermore, by providing a substrate that has a depth that that is greater than the heights of the first and second walls of the hinge receiver, front side ends of the first wall and the second walls may be buried in the substrate, so that the hinge receiver is not exposed from a front side of the substrate. However, it should be noted that any heights of the first wall 30 and the second walls 34 are suitable, so long as a depth of a cavity formed by the first wall 30 is deep enough to fully receive a cup of a European style concealed hinge, and/or depths of cavities formed by the second walls 34 are deep enough to fully receive pegs of a European style concealed hinge. If the heights of the first and second walls greater than a depth of a substrate in which the hinge receiver is set, the first and second walls may be exposed on a front side of the substrate.

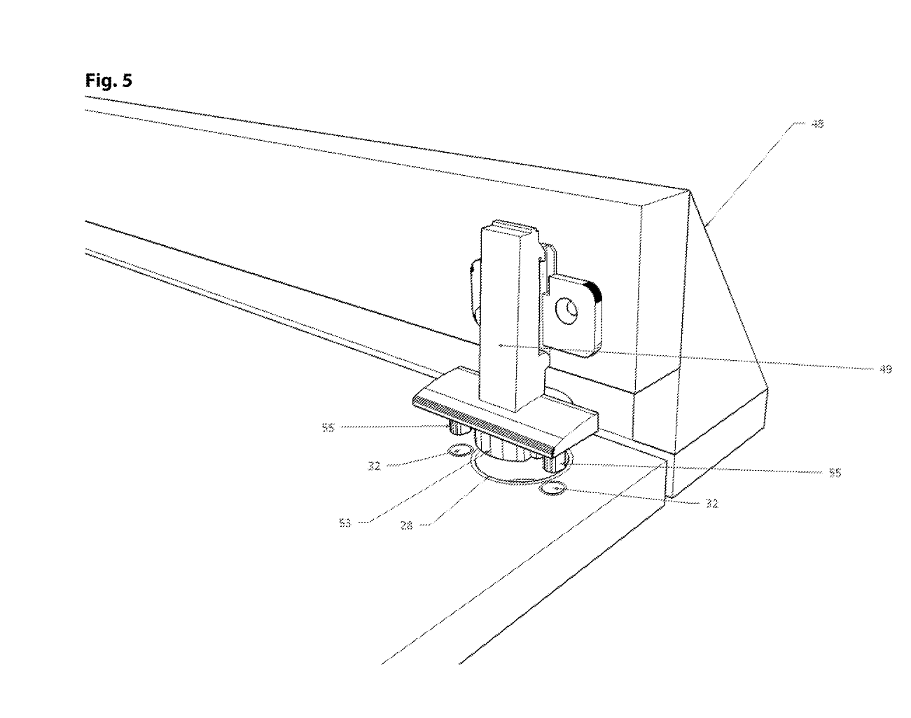

FIG. 5 illustrates an embodiment of a jig 48 including an attachment apparatus 49. The hinge receiver may be held in position by the jig 48 during a casting process. In this embodiment, a cup 53 of the attachment apparatus may fit within and attach to a cavity that is accessible through the aperture 28 of the hinge receiver, and pegs 55 of the attachment apparatus may fit within and attach to cavities that are accessible through the two holes 32 that are adjacent to the aperture of the hinge receiver. A material, such as a cement based material, concrete, glass fiber reinforced concrete, a resinous material, a composite material, a clay/ceramic matrix material, etc., may be placed or poured into a form and allowed to set around the hinge receiver, while the jig 48 retains the hinge receiver via the attachment apparatus. After the material sets, the attachment apparatus 49 may be detached from the hinge receiver, and the jig 48 and the form may be removed. FIG. 5 illustrates the jig 48 at a stage after the material of the substrate has been placed or poured and allowed to set, and the attachment apparatus 49 has been detached from the hinge receiver. FIG. 4 illustrates the embodiment of the hinge receiver that is illustrated FIG. 5 after the jig has been removed. As illustrated in FIG. 4, a bottom portion 22 of a cup 6 of a European style concealed hinge 2 may be positioned to be placed in a bottom portion of a cavity that is accessible through the aperture 28 and formed by the first wall. The pegs 14 of the hinge may be positioned to be placed in cavities that are accessible through the holes 32 and formed by the second walls. After the hinge is placed in the hinge receiver, the hinge may include a mechanism, e.g. a cam mechanism, which may be used to force an outer periphery portion of the cup outward against a circular interior of the cavity that is formed by the first wall; and/or the hinge may include a mechanism that may be used to force at least one outer portion of the pegs outward against circular interiors of the cavities that are formed by the second walls. Such outward expansion of the outer periphery portion of the cup and/or the outer portion of the pegs may attach a hinge to a hinge receiver.

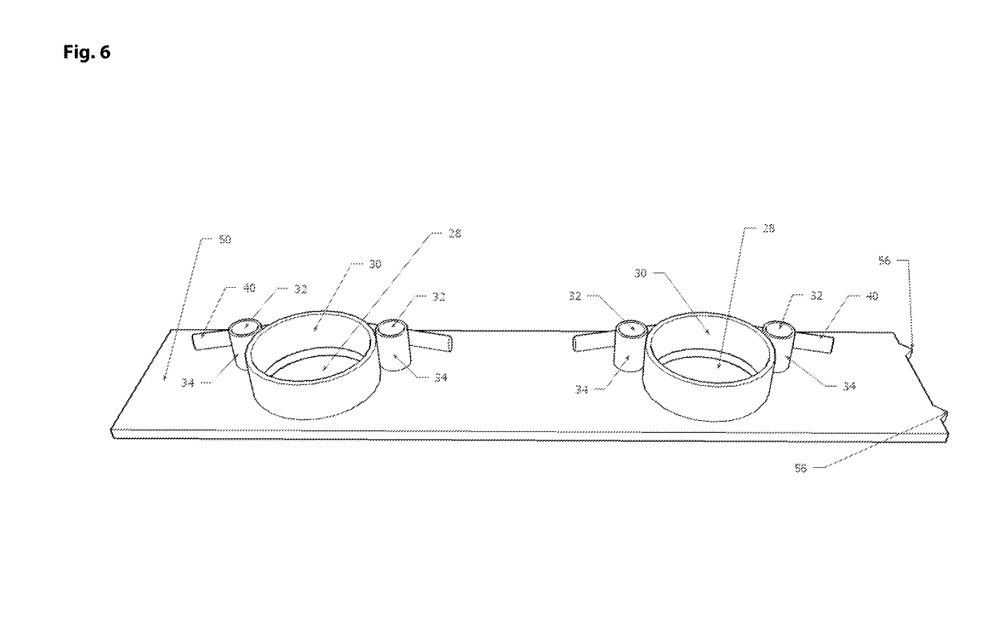

FIG. 6 illustrates a front side of another embodiment of a hinge receiver that includes a plate 50. In this embodiment, the following structure is provided. The hinge receiver includes two first walls 30 forming two apertures 28 and two second walls 34 forming two holes 32 adjacent to each of the apertures 28. Interiors of the first walls 30 and the second walls 34 are ring-shaped. The first walls 30 form cavities, e.g. cylindrical cavities, which are accessible through the apertures 28. A diameter of a cavity that is formed by a first wall 30 is the same as a diameter of an aperture 28 through which the cavity is accessible. The second walls 34 form cavities, e.g. cylindrical cavities, which are accessible through the holes 32. Diameters of cavities that are formed by the second walls 34 are the same as diameters of the holes 32. The diameters of the apertures are larger than the diameters of the holes, and the diameters of the cavities formed by the first walls 30 are larger than the diameters of the cavities that are formed by the second walls 34. For example, the holes may have a diameter of 8 mm and the apertures may have a diameter of 30 mm, 35 mm, 40 mm, etc., depending on the specific cup and/or peg sizes, and the layout of the cup and/or the pegs of a European style concealed hinge that is to be connected to the hinge receiver. The first walls 30 and the second walls 34 may be hollow cylindrical pipes. The first walls and the second walls may be attached or otherwise connected to a plate 50. In this embodiment, the longitudinal axes of the cavities formed by first wall 30 and the second walls 34 are perpendicular to a plane of a surface of the plate 50, and centers of the holes adjacent to the aperture are equidistant from a center of the aperture. A first wall 30 may be connected to the plate 50 so that at least a part of the first wall may be above a plane of a surface of the plate, and the second walls 34 may be connected to the plate so that at least a part of each of the second walls may be above the plane of the surface of the plate. Ends of the first walls 30 and the second walls 34 may be set within or disposed over cut-outs through the plate 50.

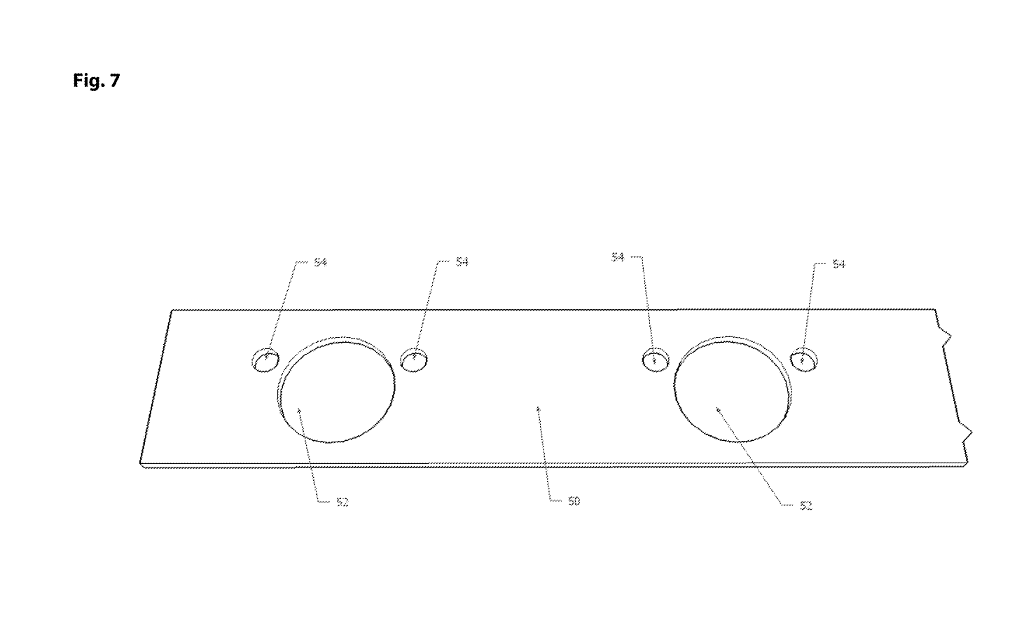

FIG. 7 illustrates the embodiment of the plate 50 that is illustrated in FIG. 6 before first walls forming apertures and second walls forming holes are connected to the plate. Ends of the first walls that may be connected to the plate may be set within or disposed over the larger diameter cut-outs 52, while ensuring that the apertures and the cavities formed by the first walls are accessible through the plate. Similarly, ends of the second walls that may be connected to the plate may be set within or disposed over the smaller diameter cut-outs 54, while ensuring that the holes and cavities formed by the second walls are accessible through the plate. The first and second walls may be attached or connected to the plate using any method such as welding, molding, casting, forging, etc.

The embodiment that is illustrated in FIG. 6 includes reinforcement members 40 adjacent to both of the first walls 30 forming the apertures 28 and the second walls 34 forming the holes 32. The reinforcement member may be attached to the first wall. The reinforcement member may be attached to at least one of the second walls adjacent to each aperture. The reinforcement member may be attached the plate. The reinforcement member may be attached to any combination of the plate, the first walls, and/or the second walls. In another embodiment, a hinge receiver may have the structure that is illustrated in FIG. 6, but the reinforcement member may be omitted from the hinge receiver. FIG. 6 also illustrates nibs 56 formed on one edge of the plate 50. Nibs may be formed on any edge of a plate of a hinge receiver. A purpose of the nibs is discussed below.

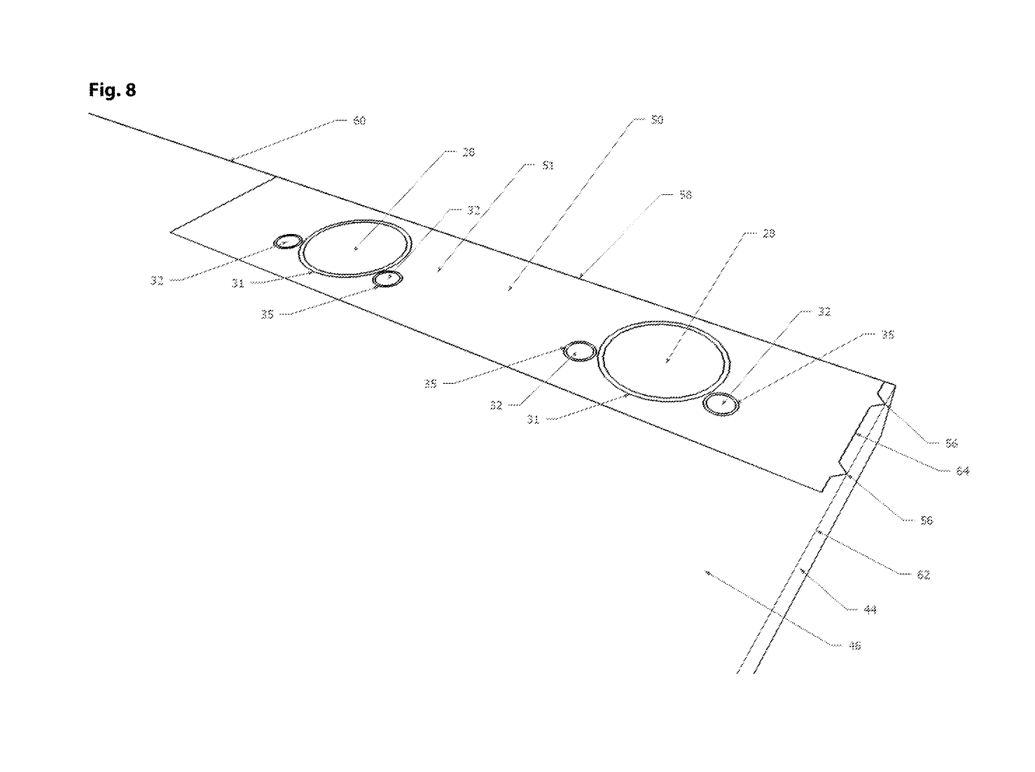

A hinge receiver including a plate 50 may be placed in a form, and then a material such as a cement based material, concrete, glass fiber reinforced concrete, a resinous material, a composite material, a clay/ceramic matrix material, etc., which may be used to form the substrate, may be poured or placed around the hinge receiver. FIG. 8 illustrates a backside view of the embodiment of the hinge receiver that is illustrated in FIG. 6, after a substrate has been formed around the hinge receiver. In the embodiment that is illustrated in FIG. 8, backside ends 31 of the first walls forming the apertures 28 and backside ends 35 the second walls forming the holes 32 are flush with the backside 51 of the plate 50, and the backside 51 of the plate 50 is flush with a backside 46 of the substrate 44. A height of a hinge receiver may be, for example only, ½ inch. The height of the hinge receiver may be measured to include a thickness of the plate and heights of the first wall and the second walls disposed on or within the plate. The heights of the first wall and the second walls may be measured in a longitudinal direction of cavities formed by the first wall and the second walls, where the longitudinal direction of the cavities is perpendicular to a plane of the plate. The substrate may have a depth of, for example only, ¾ inch. For example, when the height of the hinge receiver is ½ inch and the depth of the substrate is ¾ inch, the height of the hinge receiver is less than the depth of the substrate. In any configuration where a height of the hinge receiver is less than a depth of the substrate, the backside ends 31 of the of the first walls and the backside ends 35 of the second walls may be flush with the backside 46 of the substrate, while front side ends of the first walls and the second walls may be buried in the substrate. When a height of the hinge receiver is less than a depth of the substrate, the front side of the substrate may cover the hinge receiver. However, it should be noted that any heights of the first walls and the second walls are suitable, so long as depths of the cavities formed by the first walls and accessible through the apertures are deep enough to fully receive cups of European style concealed hinges, and/or depths of the cavities formed by the second walls and accessible through the holes are deep enough to fully receive pegs from European style concealed hinges.

In another embodiment of a hinge receiver, a plate is disposed in an intermediate region between front side and backside ends of a first wall, e.g. a pipe, and front side and backside ends of second walls, e.g. pipes. In this embodiment, a plane of the plate is perpendicular to longitudinal axes of cavities formed by the first wall and the second walls. After the substrate sets around the hinge receiver, the plate of this embodiment may be completely buried in the substrate.

In the embodiment that is illustrated in FIG. 8, the hinge receiver is set in a corner of a substrate 44. In this embodiment, the structure is as follows. One edge 58 of the plate 50 is flush with one edge 60 of the substrate. The nibs 56 are formed on one end of the plate and extend to another edge 62 of the substrate. The nibs 56 may keep the plate in position along the edge 62 of the substrate while the material of the substrate is poured or placed in a form and allowed to set around the hinge receiver. For example, while the ends of the nibs 56 are positioned on the edge 62 of the substrate, the nibs may prevent an entire edge 64 of the plate 50 of the hinge receiver from being exposed along the edge 62 of the substrate.

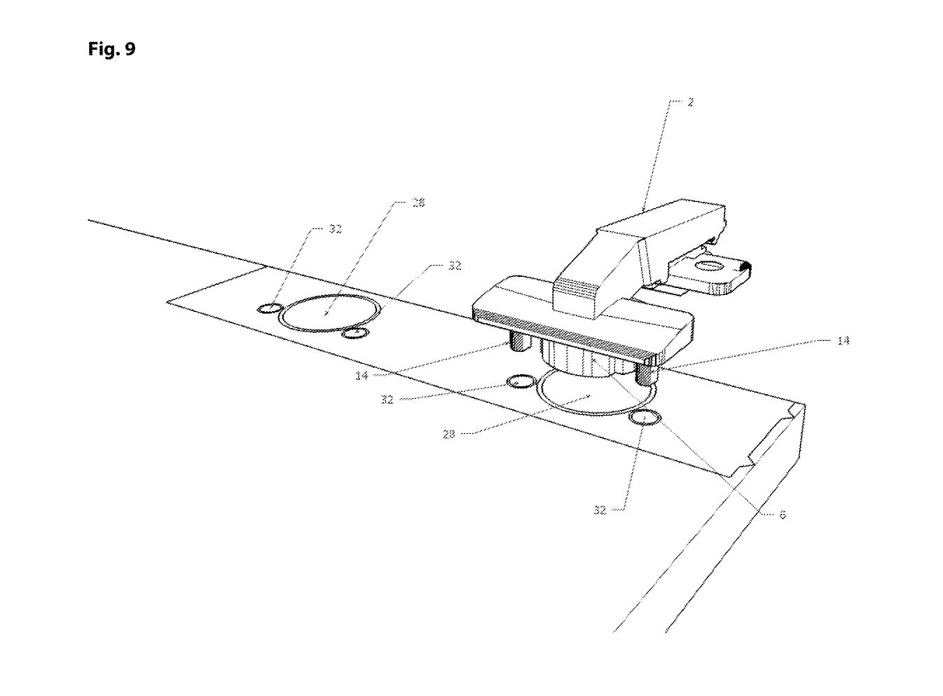

FIG. 9 illustrates a European style concealed hinge 2 aligned with a portion of the embodiment of the hinge receiver that is illustrated in FIG. 8. FIG. 9 illustrates the cup 6 of the hinge 2 in a position such that the cup 6 is aligned to fit within a cavity that is accessible through an aperture 28 of the hinge receiver, and two pegs 14 of the hinge 2 in positions such that the pegs 14 are aligned to fit within cavities that are accessible through two holes 32 of the hinge receiver. After the hinge is placed in the hinge receiver, the hinge may include a mechanism, e.g. a cam mechanism, which may be used to force an outer periphery portion of the cup 6 outward against a circular interior of the cavity that is accessible through the aperture 28; and/or the hinge may include a mechanism that may force at least one outer portion of the pegs outward against circular interiors of the cavities that are accessible through the holes 32. Such outward expansion of the outer periphery portion of the cup and/or the outer portion of the pegs may attach the hinge to a hinge receiver.

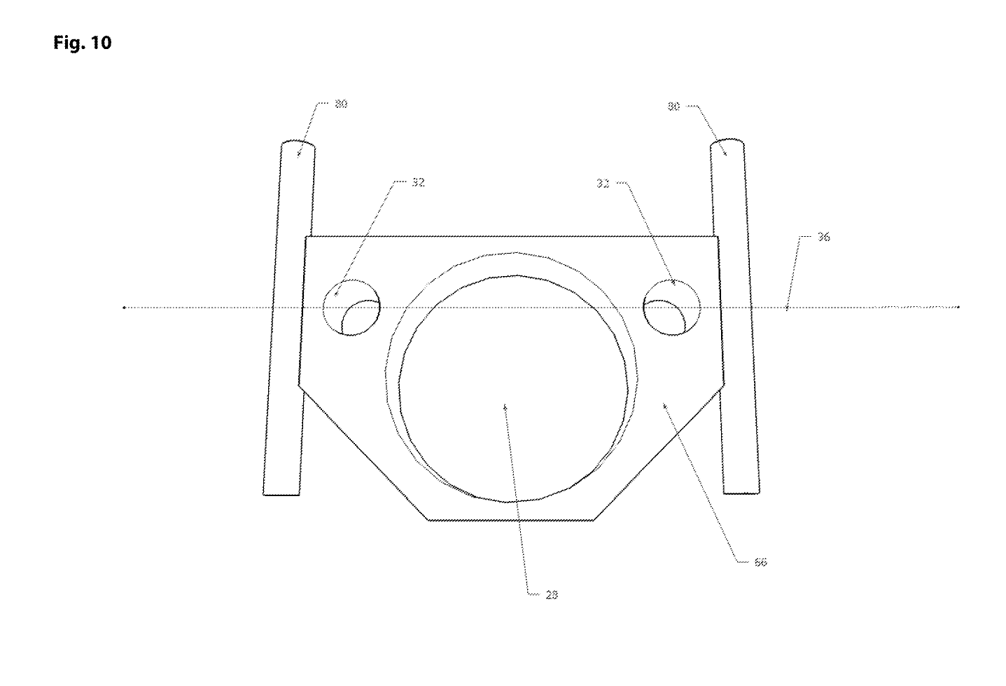

In another embodiment of the hinge receiver that is illustrated in FIG. 10, the hinge receiver includes an aperture 28 and two holes 32 adjacent to the aperture, and the holes and aperture are formed in a block body 66. In this embodiment, the structure is as follows. The aperture 28 and a cavity in the block body that is accessible through the aperture have the same diameter. The aperture 28 and the cavity in the block body that is accessible through the aperture are formed by a ring-shaped interior first wall that is formed within the block body 66. The holes 32 and cavities in the block body that are accessible through the holes have the same diameter. The holes 32 and the cavities in the block body that are accessible through the holes are formed by ring-shaped interior second walls that are formed within the block body 66. A diameter of the aperture is larger than diameters of the holes. For example, the holes may have a diameter of 8 mm and the aperture may have a diameter of 30 mm, 35 mm, 40 mm, etc., depending on the specific cup and/or peg sizes, and the layout of the cup and/or the pegs of a hinge to be attached to a hinge receiver. Centers of the holes may be equidistant from a center of the aperture. It is possible that a straight line 36 passing through centers of the two holes 32 adjacent to the aperture 28 does not pass through a center of the aperture. It is also possible that another straight line, which is perpendicular to longitudinal axes of the cavities that are accessible through the two holes, passes through centers of circular cross-sections of the cavities that are accessible through the two holes and does not pass through a center of a circular cross-section of the cavity that is accessible through the aperture. At least one reinforcement member 80 may be disposed outside the block body 66. The reinforcement member may be attached to the block body by any method such as welding, molding, casting, forging, extruding, etc. The reinforcement member may be oblong and may have any cross-sectional shape such as rectangular, circular, elliptical, flat, polygonal, etc. In the embodiment that is illustrated in FIG. 10, two reinforcement members 80 are attached to opposite sides of the block body 66. In another embodiment, multiple block bodies may be connected together with one or more reinforcement members.

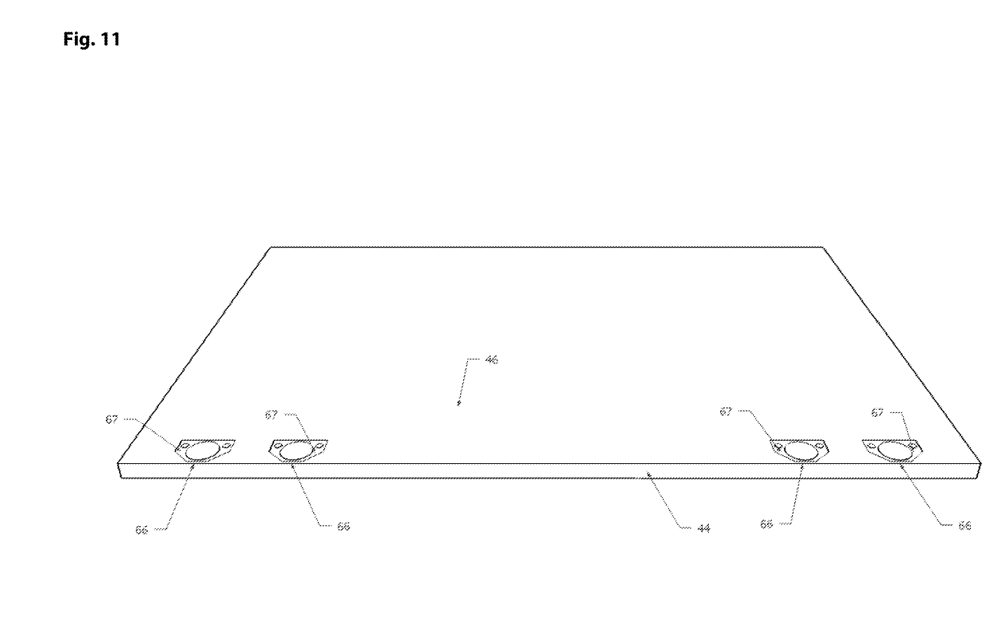

FIG. 11 illustrates multiple hinge receivers, as illustrated in FIG. 10, set within a material that forms a substrate, such as a door, a cabinet door, etc., made of a material such as a cement based material, concrete, glass fiber reinforced concrete, a resinous material, a composite material, a clay/ceramic matrix material, etc. FIG. 11 illustrates a backside 46 of the substrate 44 where four block bodies of the hinge receivers are set within the material of the substrate. The block bodies may have thicknesses of, for example only, ½ inch along longitudinal axes of cavities that are accessible through the apertures and the holes; and the substrate may have a depth of, for example only, ¾ inch, so that the thickness of each of the block bodies is less than the depth of the substrate. In the embodiment that is illustrated in FIG. 11, backside surfaces 67 of the block bodies 66 are flush with a backside 46 of the substrate. When a thickness of each of the block bodies is less than a depth of the substrate, front side surfaces of the block bodies may be buried in the substrate and the front side of the substrate may cover the hinge receivers. On the other hand, if the block bodies are configured to have thicknesses that are greater than a depth of the substrate in which the block bodies are embedded, it is possible that the front side of the substrate will not cover the hinge receivers. However, it should be noted that any thickness of a block body is suitable, so long as a depth of the cavity that is accessible through the aperture is deep enough to fully receive a cup of a European style concealed hinge, and/or depths of the cavities that are accessible through the holes are deep enough to fully receive the pegs of a European style concealed hinge.

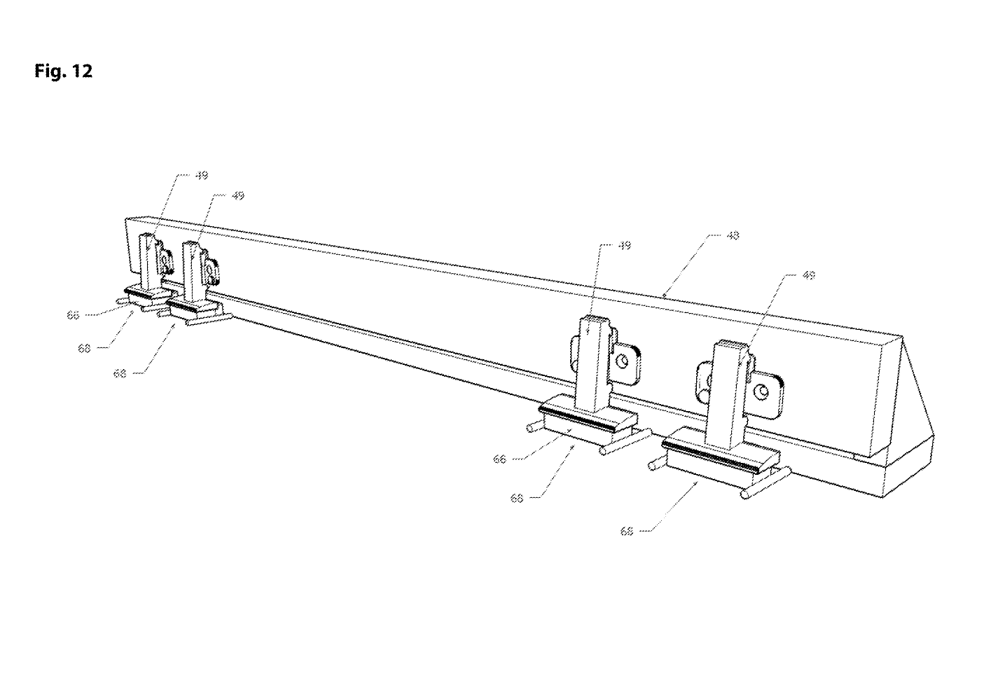

FIG. 12 illustrates an embodiment of a jig 48 including attachment apparatuses 49 retaining hinge receivers 68 according to the embodiment that is illustrated in FIG. 10. In the embodiment that is illustrated in FIG. 12, the attachment apparatuses 49 each include a cup and pegs, such that the cup of an attachment apparatus fits within the cavity that is accessible through the aperture in the block body 66, and the pegs fit within the cavities that are accessible through the holes in the block body 66, so that the hinge receivers 68 are held in place by the jig 48 while forming a substrate, such as a door, a cabinet door, etc., around the hinge receivers. The jig may be used to retain the hinge receivers in a designated position inside a form while a material is poured, formed, or placed around the hinge receivers, in order to embed the hinge receivers in specific locations in a substrate.

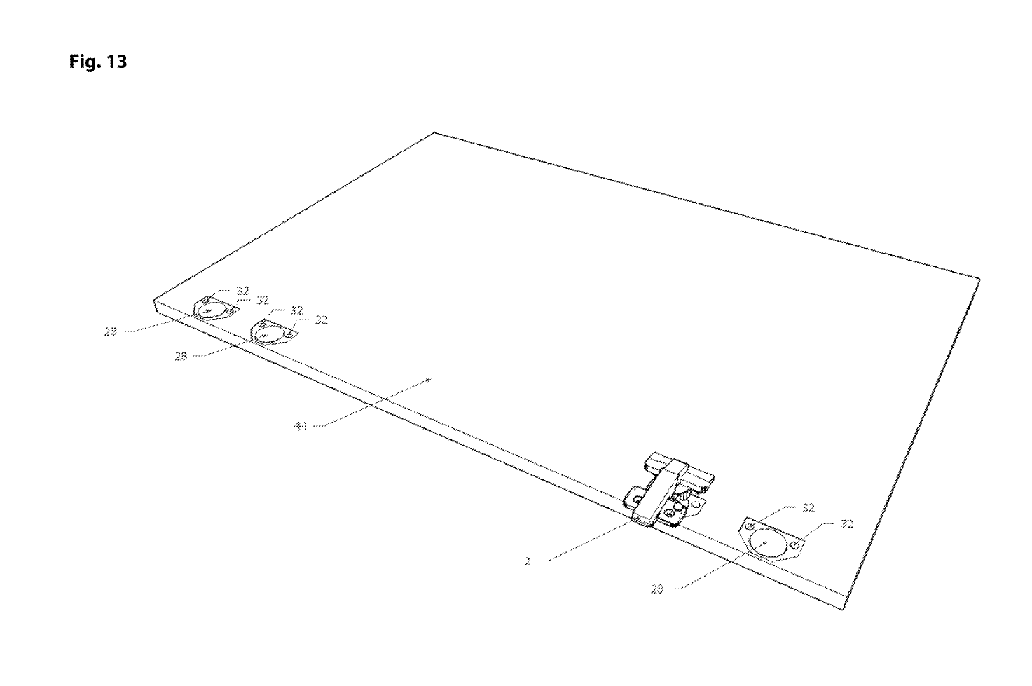

FIG. 13 illustrates a European style concealed hinge 2 positioned above one of the block bodies of the embodiment that is illustrated in FIG. 11. Cavities that are accessible through apertures 28 of each of the block bodies may receive a cup of a European style concealed hinge, and cavities that are accessible through each of the holes 32 adjacent to each aperture may each receive a peg from a European style concealed hinge. While FIGS. 11 and 13 illustrate four block bodies 66 set within a material forming a substrate, such as door, a cabinet door, etc., it should be noted that any number of block bodies may be set in the substrate. For example, one, two, three, four, five, six or more block bodies may be set in the substrate. The block bodies 66 may be set in the substrate in pairs, as illustrated in FIGS. 11 and 13. However, the block bodies may be set in a substrate any configuration that is necessary to receive hinges.

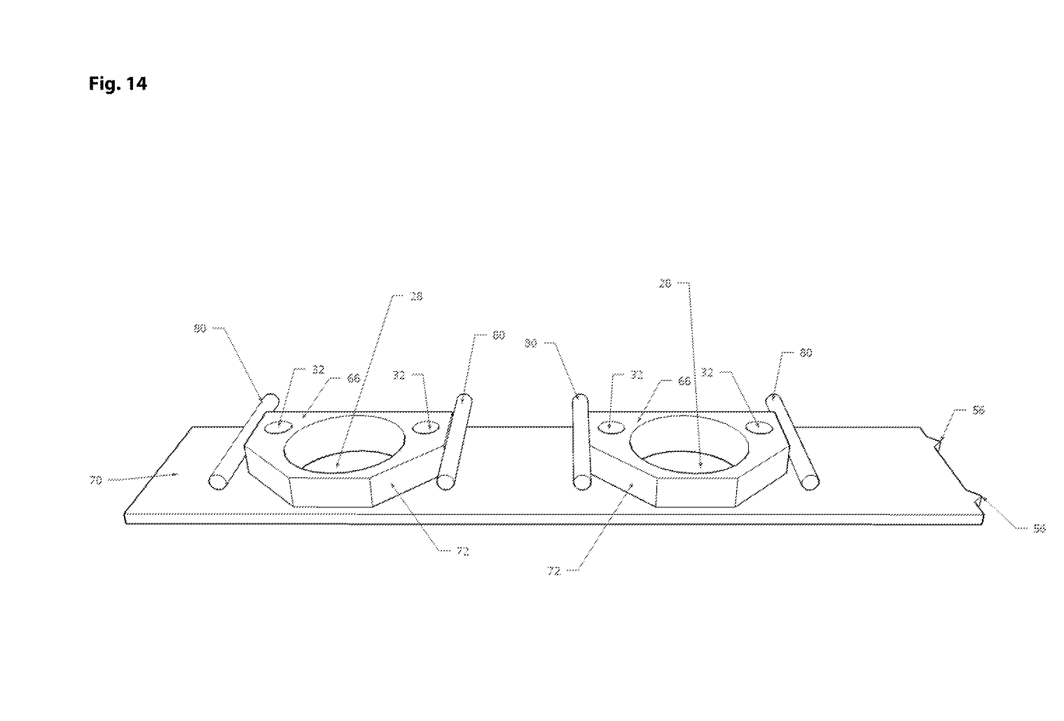

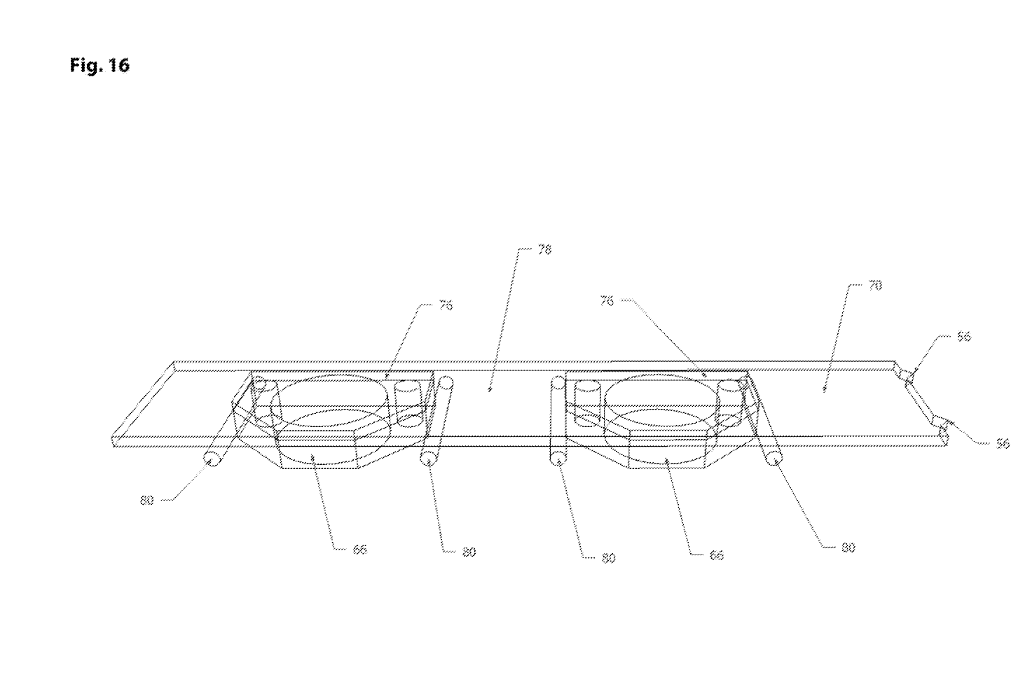

FIGS. 14 and 16 illustrate preferred embodiments of a hinge receiver including two block bodies 66 attached to a plate 70. FIG. 14 illustrates a front side view of a hinge receiver including the two block bodies 66. In the embodiments that are illustrated in FIGS. 14 and 16, the structure is as follows. Each of the block bodies 66 includes an aperture 28 and two holes 32 adjacent to the aperture. The diameter of the aperture is larger than diameters of the holes adjacent to the aperture. A diameter of a cavity in the block body that is accessible through the aperture 28 is the same as the diameter of the aperture. The cavity in the block body that is accessible through the aperture 28 is formed by a ring-shaped interior wall that is formed within the block body 66. The holes 32 have the same diameter, and diameters of cavities in the block body that are accessible through the holes 32 are the same as the diameters of the holes. The cavities in the block body that are accessible through the holes 32 are formed by ring-shaped interior walls that are formed within the block body 66. For example, the holes may have a diameter of 8 mm and the aperture may have a diameter of 30 mm, 35 mm, 40 mm, etc., depending on the specific cup and/or peg sizes, and the layout of the cup and/or the pegs of a hinge to be attached to the hinge receiver. Lower portions 72 of each of the block bodies may be placed through or disposed over cut-outs formed through the plate. Nibs 56 may be formed on any edge of the plate 70.

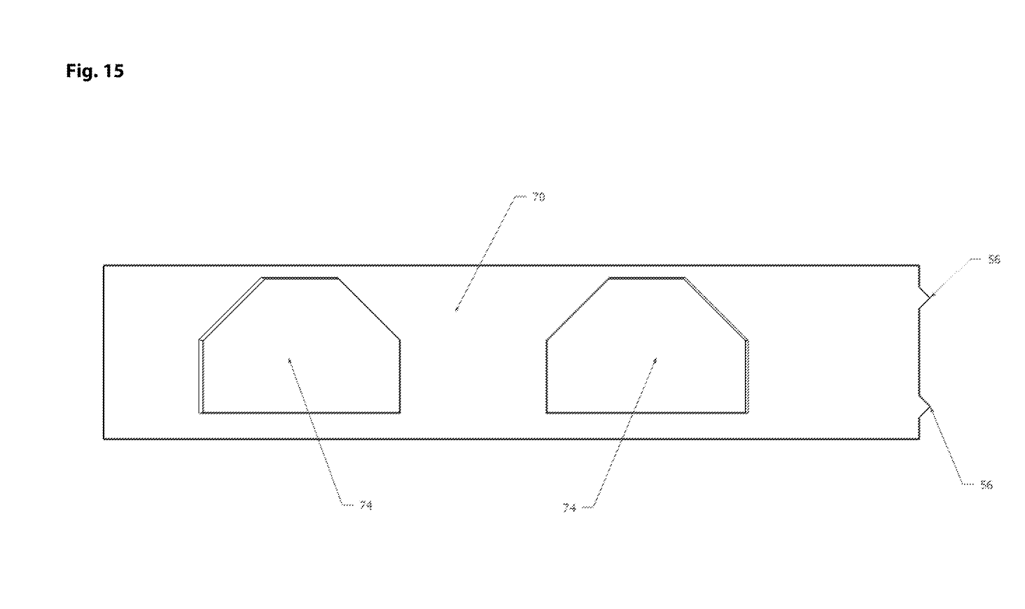

FIG. 15 illustrates an embodiment of a plate 70 including cut-outs 74 before placement of block bodies on the plate. The block bodies may be placed over the cut-outs and be attached to a surface of the plate, or the block bodies may be fitted within the cut-outs. It is important that the holes and the aperture in each block body are accessible through the plate via at least one cut-out once the block bodies are disposed on the plate. Each of the cut-outs may have a shape and dimensions that are configured to receive and surround the shape of a block body.

FIG. 16 illustrates a transparent backside view of a preferred embodiment of a hinge receiver. In this embodiment, the structure is as follows. The block bodies are disposed through cut-outs through the plate, and backside surfaces 76 of the block bodies 66 are flush with a backside 78 of the plate 70. In another embodiment, the backside surfaces of the block bodies are placed on a surface of the plate, instead of through cut-outs through the plate, while ensuring that the aperture and the holes of the block bodies are accessible through at least one cut-out through the plate.

A hinge receiver may include at least one reinforcement member. A reinforcement member may be attached to the plate and/or the block bodies. In the embodiments that are illustrated in FIGS. 14 and 16, two reinforcement members 80 are attached to opposite sides of each of the block bodies 66.

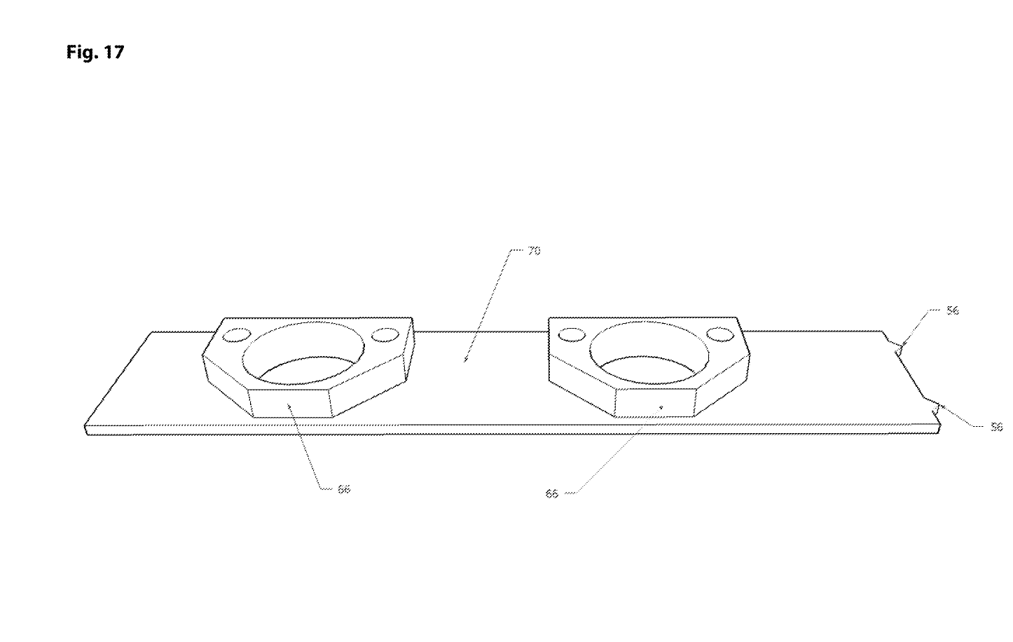

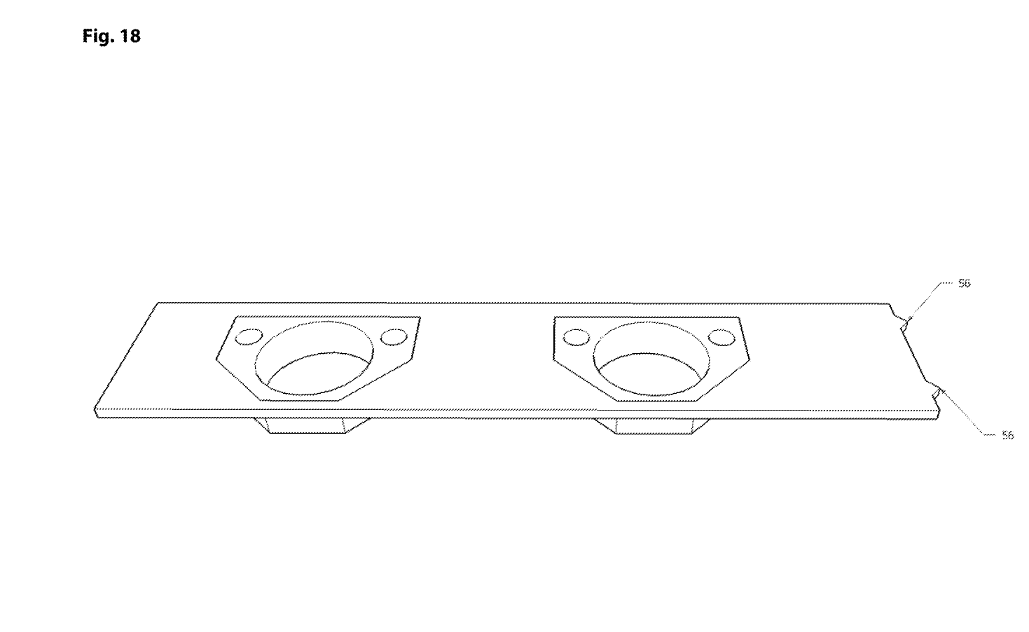

FIG. 17 illustrates a front side view of another embodiment of a hinge receiver including block bodies 66 disposed through plates 70, wherein reinforcement members are not included. FIG. 18 illustrates a backside view of the embodiment of the hinge receiver that is illustrated in FIG. 17.

In addition, FIGS. 14-18 illustrate nibs 56 formed on an edge of the plate. Nibs may be formed on any edge of a plate of a hinge receiver. The nibs are discussed below with respect to the hinge receiver set in a material forming a substrate, such as a door, a cabinet door, etc.

While a hinge receiver including a plate may include two block bodies 66, such that each block body includes an aperture 28 and two holes 32, a hinge receiver including a plate may include any number of the block bodies such as one, two, three, four, five, six or more block bodies. Furthermore, the block bodies may be spaced evenly along a length of the plate, or the block bodies may be spaced in any configuration, including pairs or groupings of the block bodies. The block bodies may be arranged in any configuration on the plate in order to allow the block bodies to receive and be connected to European style concealed hinges.

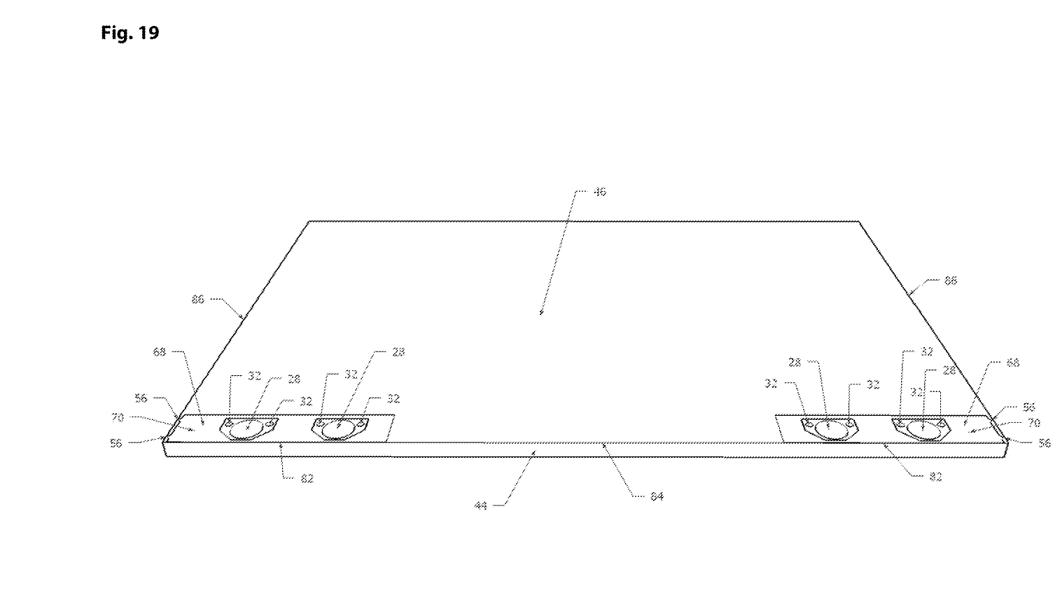

FIG. 19 illustrates a backside view of two embodiments of hinge receivers 68, each including a plate 70 and two block bodies 66, set in a substrate 44. The substrate may be formed from a material, such as a cement based material, concrete, glass fiber reinforced concrete, a resinous material, a composite material, a clay/ceramic matrix material, etc., that is poured or placed around the hinge receivers 68. The material may be used to form a substrate, such as a door, a cabinet door, etc. The hinge receivers may have thicknesses of, for example only, ½ inch, while the substrate may have a depth of, for example only, ¾ inch, so that the thicknesses of the hinge receivers are less than the depth of the substrate. A thickness of the hinge receiver may include the thickness of the plate and the thicknesses of the block bodies on the plate. The thicknesses of the block bodies may be measured in a direction along longitudinal axes of the cavities that are accessible through the aperture and the holes in each block body. In FIG. 19, the backside surfaces of the plates 70, as well as the backside surfaces of each of the block bodies 66 are flush with a backside 46 of the substrate. When thicknesses of the hinge receivers are less than a depth of the substrate, front side surfaces of the block bodies of the hinge receivers may be buried in the substrate, such that the front side surfaces of the hinge receivers are not exposed from a front side of the substrate. Burying front side surfaces of the block bodies in the substrate may ensure that the front side of the substrate covers the hinge receivers. If a thickness of a hinge receiver is greater than a depth of the substrate, the hinge receiver may be exposed from the front side of the substrate. However, the hinge receivers may have any thickness, so long as a depth of a cavity that is accessible through the aperture 28 formed in each block body is deep enough to fully receive a cup of a European style concealed hinge, and/or depths of cavities that are accessible through the holes 32 formed in each block body are deep enough to fully receive the pegs of a European style concealed hinge.

In another embodiment, a plate is attached to at least one block body in an intermediate region between a front side surface and a backside surface of the block body, so that a plane of the plate is perpendicular to longitudinal axes of cavities that are accessible through the apertures and the holes of the block body. The plate may be fully buried in a substrate after the material from which the substrate is formed sets around the hinge receiver.

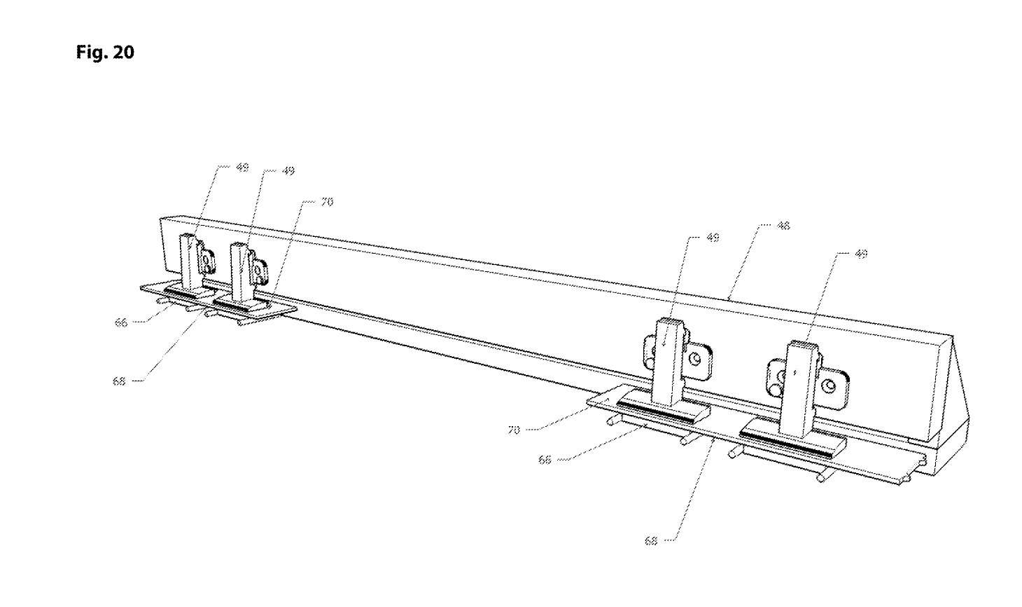

FIG. 20 illustrates an embodiment of a jig 48 including attachment apparatuses 49 retaining hinge receivers 68, which each include a plate 70 and block bodies 66. In this embodiment, the attachment apparatuses 49 each include a cup and pegs, such that the cup of an attachment apparatus fits within and attaches to a cavity that is accessible through an aperture in a block body 66, and the pegs fit within and attach to cavities that are accessible through holes in the block body 66, so that the jig 48 holds the hinge receivers 68 in position within a form while a material, such as a cement based material, concrete, glass fiber reinforced concrete, a resinous material, a composite material, a clay/ceramic matrix material, etc., is poured into the form and sets around the hinge receivers. After the material sets, the attachment apparatuses may be detached from the hinge receivers and the jig 48 and the form may be removed.

While FIG. 19 illustrates two embodiments of hinge receivers 68 set in opposite corners of a substrate, it is noted that one, two, three, four, five, six, or more hinge receivers, each including any number of block bodies may be formed in the substrate. FIG. 19 illustrates nibs 56 formed on one end of each of the plates 70 of the hinge receivers, and the nibs 56 on one of the plates point in an opposite direction from the nibs on the other plate. Nibs may be placed or formed on any edge of a plate of a hinge receiver, as needed. In FIG. 19, a longer edge 82 of each plate 70 of the hinge receivers is flush with a longer edge 84 of the substrate 44, and the nibs 56 formed on an end of each of the plates extend to shorter edges 86 of the substrate.

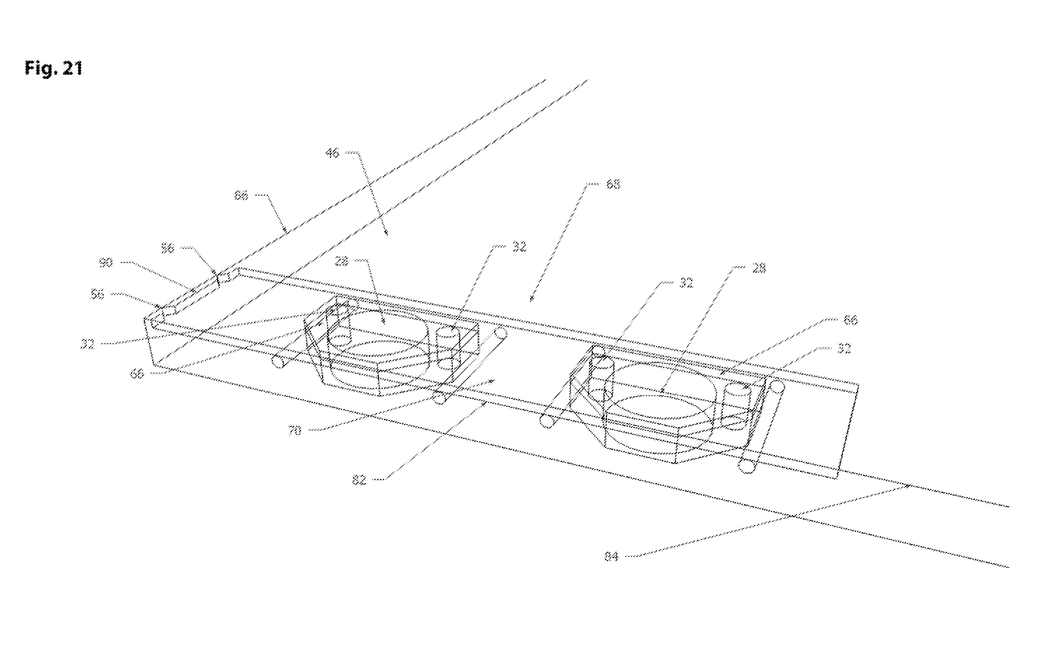

FIG. 21 illustrates a transparent backside view of one of the hinge receivers 68 that is illustrated in FIG. 19. The structure of this embodiment of a hinge receiver is as follows. The hinge receiver 68 includes two block bodies 66 and a plate 70 exposed on a backside 46 of the substrate. A longer edge 82 of the plate 70 is flush with a longer edge 84 of the substrate, and the nibs 56 formed on one end of the plate extend to the shorter edge 86 of the substrate. When pouring or placing a material around a hinge receiver in a form, in order to obtain the hinge receiver embedded in a substrate, the nibs 56 may be positioned against an edge of the form so that ends of the nibs extend to a shorter edge 86 of a substrate formed from the material. When the ends of the nibs 56 are positioned on the shorter edge 86 of the substrate, the nibs prevent the shorter edge 90 of the plate of the hinge receiver from being exposed along the shorter edge 86 of the substrate. After a European style concealed hinge is placed in the hinge receiver, the hinge may include a mechanism, e.g. a cam mechanism, which may be used to force an outer periphery portion of the cup of the hinge outward against a circular interior of the cavity accessible through the aperture 28; and/or the hinge may include a mechanism that may force at least one outer portion of the pegs of the hinge outward against circular interiors of the cavities that are accessible through the holes 32. Such outward expansion of the outer periphery portion of the cup and/or the outer portion of the pegs may attach the hinge to a hinge receiver.

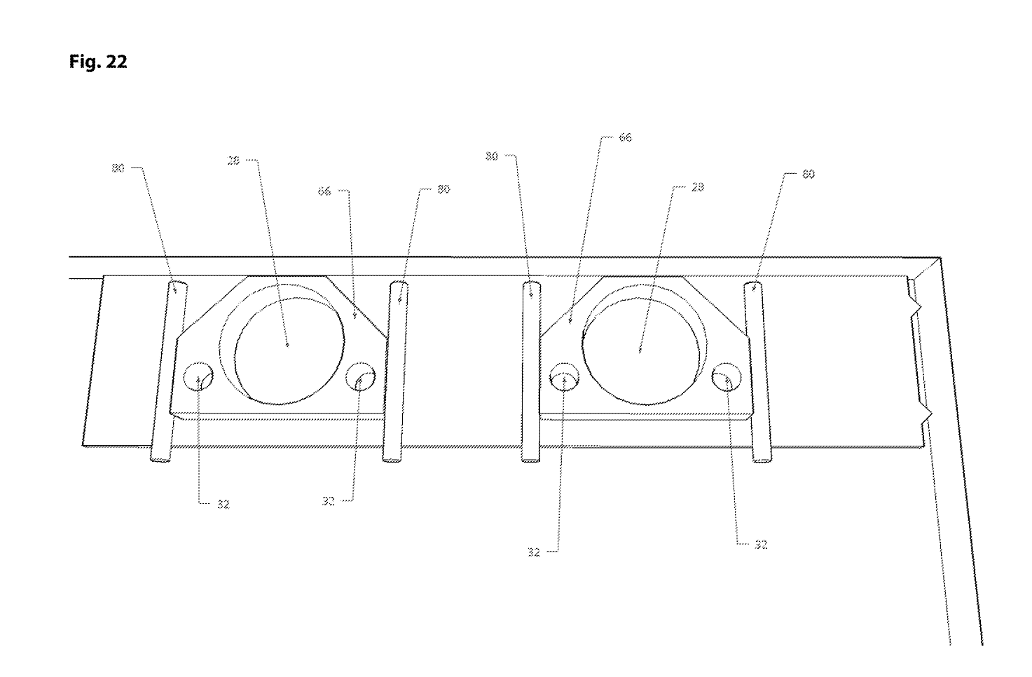

FIG. 22 illustrates a front side view of one of the hinge receivers that is illustrated in FIG. 19 viewed through a transparent rendering of the substrate. The embodiment of the hinge receiver that is illustrated in FIG. 22 includes the following structure. The hinge receiver includes two block bodies 66, and the block bodies each include an aperture 28 and two holes 32. Each of the block bodies includes two reinforcement members 80 formed on opposite sides of the block bodies. The reinforcement members are buried in the material of the substrate, in order to prevent the hinge receiver from pulling out of the substrate.

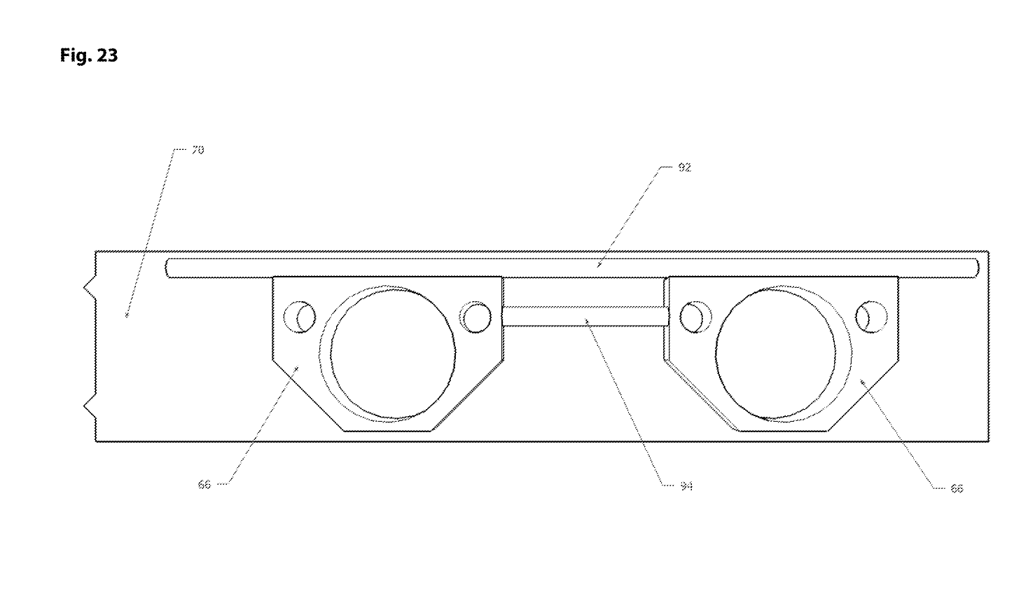

FIG. 23 illustrates another embodiment of a hinge receiver including a longer reinforcement member 92 and a shorter reinforcement member 94 attached to two block bodies 66. This embodiment of a hinge receiver includes the following structure. The longer reinforcement 92 member is longer than a distance between the two block bodies 66, and a side of the longer reinforcement member 92 is attached to both block bodies in a position adjacent to an edge of the plate 70. In addition, the shorter reinforcement 94 member is disposed in a position between both of the block bodies 66, and opposite ends of the shorter reinforcement member 94 are attached to sides of both of the block bodies.

An embodiment of a method of fabricating a door includes a step of placing at least one hinge receiver in a form, such as a five-walled box. A hinge receiver may be placed in the form before filling the form with a material, such as a cement based material, concrete, glass fiber reinforced concrete, a resinous material, a composite material, a clay/ceramic matrix material, etc., which is used to form the substrate. An example of such a form may include a main wall. When a material from which a substrate is formed is placed in form, the main wall may form a first main surface of the substrate when the material of the substrate sets. The form may have four secondary walls that are perpendicular to the main wall. The four secondary walls may form minor surfaces of the substrate when the material of the substrate sets. The form may also include a top opening. After the form is filled with the material of the substrate, the top opening may allow formation a second main surface of the substrate when the material of the substrate sets. In this embodiment of the method of fabricating a door, a hinge receiver that is placed in the form includes a first ring wall and two second ring walls adjacent to the first ring wall. Multiple hinge receivers may be placed in a form. A hinge receiver that is placed in the form may include any number of first ring walls and two second ring walls adjacent to each of the first ring walls. For example, the hinge receiver may include one, two, three, four, five, six, or more first ring walls, and two second ring walls adjacent to each of the first ring walls. Each first ring wall may form a cavity that is accessible through an aperture and the second ring walls may form cavities that are accessible through holes. In this embodiment of a method of fabricating a door, a longitudinal axis of the first ring wall is parallel to longitudinal axes of the second ring walls adjacent to the first ring wall; and the longitudinal axes of the first ring wall and the second ring walls are perpendicular to the main wall of the form and the first and second main surfaces of a substrate. In addition, it is possible that a straight line passing through centers of the second ring walls adjacent to the first ring wall does not pass through a center of the first ring wall. It is also possible that a straight line perpendicular to longitudinal axes of the second ring walls adjacent to the first ring wall and passing through a center of a circular cross-section of each of the two second ring walls does not pass through a center of a circular cross section of the first ring wall.

An embodiment of a method of fabricating a door includes a step of filling the form with a material without filling an aperture formed by a first ring wall and holes formed by second ring walls. The aperture and the holes adjacent to the aperture may be covered while filling the form with the material used to form the substrate, in order to avoid filling the aperture and the holes. In one embodiment, tape is placed over the aperture and the holes, and the tape covered aperture and holes are placed face down in a form before filling the form with a material that is used to form a substrate. When the form is filled with the material, the tape covering the holes and the aperture may prevent the material from rising within the holes and the apertures from face down sides of the holes and the apertures that are covered with the tape. In addition, another embodiment of the method of fabricating a door includes filling a form with a material while avoiding filling the aperture and the holes, without covering the aperture and the holes. A method of fabricating a door may also include a step of allowing the material to set, after the form has been filled with the material.

An embodiment of a method of fabricating a door includes retaining at least one hinge receiver in a form with a jig while filling the form. In this embodiment, the jig retains a first ring wall of a hinge receiver and/or at least one of the second ring walls adjacent to the first ring wall. In addition, in the case of multiple first ring walls, the jig may retain each first ring wall and/or at least one of the second ring walls adjacent to each first ring wall. The first ring wall may be a pipe and the second ring walls may be pipes. A diameter of a first ring wall may be larger than diameters of the second ring walls, and the diameters of the second ring walls may be the same. The pipes of the first ring wall and the second ring walls may be retained by the jig. In addition, while filling the form with a material, the jig may retain the first ring wall and the second ring walls perpendicular to a main wall of a form so that the longitudinal axes of the first ring wall forming the aperture of the hinge receiver and the second ring walls forming holes of the hinge receiver may be parallel to one another and perpendicular to the main wall of the form.

An embodiment of a method of fabricating a hinge receiver includes forming a first ring wall adjacent to two second ring walls. In this embodiment, the first ring has a diameter that is larger than the diameters of the two second ring walls. It is possible that a straight line passing through centers of the two second ring walls adjacent to the first ring wall does not pass through a center of the first ring wall. It is also possible that a straight line perpendicular to longitudinal axes of the second ring walls adjacent to the first ring wall and passing through a center of a circular cross-section of the two second ring walls does not pass through a center of a circular cross section of the first ring wall. An embodiment of a method of fabricating the hinge receiver includes forming the first ring wall and the second ring walls so that a longitudinal axis of the first ring wall is parallel to longitudinal axes of the second ring walls. An embodiment of a method of fabricating the hinge receiver includes placing at least one reinforcement member adjacent to at least the first ring wall and/or at least one of the second ring walls. For example, the method may include attaching a reinforcement member to the first ring wall and/or one or more of the second ring walls, and the attachment may be accomplished by welding, molding, casting, forging, extruding, etc.

An embodiment of a method of fabricating a hinge receiver includes forming a first ring wall adjacent to second ring walls by extruding a member including a first tube adjacent to two second tubes. In this embodiment, the first tube extends in a longitudinal direction through the extruded member, and the two second tubes extend in the longitudinal direction through the extruded member. In the extruded member of this embodiment, a longitudinal axis of the first tube is parallel to longitudinal axes of the second tubes. The extruded member may be diced into block bodies, where each of the block bodies includes the first ring wall formed from part of the first tube and the two second ring walls formed from parts of the second tubes.

An embodiment of a method of fabricating the hinge receiver includes forming the first ring wall adjacent to the second ring walls by attaching the first ring wall to the second ring walls. For example, the first ring wall may be attached to two second ring walls by welding, molding, casting, forging, extruding, etc. In one embodiment, the first ring wall and the second ring walls are formed of pipes, and each pipe forming the first ring wall is attached to two pipes forming the second ring walls. The pipes forming the first ring wall and the second ring walls may be attached together so that longitudinal axes of the pipes are parallel. It is possible that a straight line passing through centers of each of the pipes forming the second ring walls adjacent to the first ring wall does not pass through a center of the first ring wall. It is also possible that a straight line perpendicular to longitudinal axes of the pipes forming the second ring walls adjacent to the pipe forming the first ring wall and passing through a center of a circular cross-section of the two second ring walls does not pass through a center of a circular cross section of the first ring wall.

An embodiment of a method of fabricating the hinge receiver includes casting a member including a first tube adjacent to two second tubes. In the cast member, a longitudinal axis of the first tube may be parallel to longitudinal axes of the second tubes.

The exemplary embodiments shown in the figures and described above illustrate but do not limit the subject matter disclosed in this specification. It should be understood that there is no intention to limit the subject matter in this specification to the specific form disclosed; rather, the disclosed subject matter is to cover all modifications, alternative constructions, and equivalents falling within the spirit and scope of the subject matter recited in the claims.

What is claimed is:

1. A hinge receiver comprising:
at least one aperture defined by a first wall;
at least two holes defined by second walls; and
at least one reinforcement member adjacent to at least the first wall or at least one of the second walls;
wherein the at least two holes are adjacent to the at least one aperture, a dimension of the at least one aperture is larger than dimensions of the at least two holes, and a straight line through centers of the at least two holes does not cross a center of the at least one aperture.

2. The hinge receiver according to claim 1, further comprising a plate, the first wall being connected to the plate with at least a part of the first wall being disposed above a plane of a surface of the plate; and the second walls being connected to the plate with at least a part of each of the second walls being disposed above the plane of the surface of the plate.

3. The hinge receiver according to claim 2, wherein the first wall and the second walls are hollow cylindrical pipes, and the first wall and the second walls have longitudinal axes perpendicular to the plane of the surface of the plate.

4. The hinge receiver according to claim 1, wherein the at least one aperture defined by the first wall and the at least two holes defined by the second walls are formed in a block body, and the at least one reinforcement member is disposed outside the block body.

5. A door comprising the hinge receiver according to claim 1, wherein the first wall, the second walls, and the at least one reinforcement member are disposed within a body of the door, and the at least one aperture and the at least two holes are exposed on a side of the body of the door.

6. The door according to claim 5, wherein the hinge receiver is set within a material forming the body of the door.

7. The door according to claim 6, wherein the material is selected from the group consisting of cement based materials, concrete, glass fiber reinforced concrete, resinous materials, composite materials, and clay/ceramic matrix materials.

8. A door comprising:
a substrate;
a hinge receiver embedded in the substrate, the hinge receiver comprising at least one aperture defined by a ring-shaped first wall, and at least two holes defined by ring-shaped second walls,
wherein the at least one aperture and the at least two holes are exposed on a side of the substrate, a diameter of the at least one aperture is larger than diameters of the at least two holes, and a straight line through centers of the at least two holes does not cross a center of the at least one aperture.

9. The door according to claim 8, further comprising a plate, at least a part of the first wall being connected to a surface of the plate, and at least a part of each of the second walls being connected to the surface of the plate.

10. The door according to claim 8, wherein the substrate comprises at least one material selected from the group consisting of cement based materials, concrete, glass fiber reinforced concrete, resinous materials, composite materials, and clay/ceramic matrix materials.

11. The door according to claim 8, wherein the first wall and the second walls are pipes, and longitudinal axes of the first wall and the second walls are parallel.

12. The door according to claim 9, wherein the first wall and the second walls are pipes, and the first wall and the second walls have longitudinal axes perpendicular to a plane of the surface of the plate.

13. The door according to claim 8, further comprising at least one reinforcement member adjacent to at least the first wall or at least one of the second walls.

14. The door according to claim 13, wherein the at least one aperture defined by the first wall and the at least two holes defined by the second walls are formed in a block body, and the at least one reinforcement member is disposed outside the block body.

15. A method of fabricating a door comprising:
placing at least one hinge receiver in a form, wherein the hinge receiver comprises a first ring wall and two second ring walls adjacent to the first ring wall, and a longitudinal axis of the first ring wall is parallel to longitudinal axes of the two second ring walls, and the longitudinal axes of the first ring wall and the two second ring walls are perpendicular to a main surface of the form; and
filling the form with a material without filling an aperture formed by the first ring wall and holes formed by the two second ring walls.

16. The method according to claim 15, further comprising covering the aperture and the holes while filling the form.

17. The method according to claim 15, further comprising retaining the at least one hinge receiver in the form with a jig while filling the form.

18. A method of fabricating a hinge receiver comprising:
forming a first ring wall adjacent to two second ring walls, wherein a longitudinal axis of the first ring wall is parallel to longitudinal axes of the second ring walls; and
placing at least one reinforcement member adjacent to at least the first ring wall or at least one of the two second ring walls.

19. The method according to claim 18, wherein forming the first ring wall adjacent to the two second ring walls further comprises extruding a member comprising a first tube adjacent to two second tubes, wherein a longitudinal axis of the first tube is parallel to longitudinal axes of the two second tubes; and dicing the member into block bodies each including the first ring wall adjacent to the two second ring walls.

20. The method according to claim 18, wherein forming the first ring wall adjacent to the two second ring walls comprises attaching the first ring wall to the two second ring walls.
